(19) United States
(12) Patent Application Publication
(10) Pub. No.: US 2010/0326902 A1
(43) Pub. Date: Dec. 30, 2010

(54) Laminated Filtration Media

(76) Inventors: David Grant Midkiff, Alpharetta, GA (US); Heather M. Richmond, Rosewell, GA (US); Nina Frazier, Mableton, GA (US)

Correspondence Address: KIMBERLY-CLARK WORLDWIDE, INC.;Tara Pohlkotte, 2300 Winchester Rd., NEENAH, WI, 54956, US

(21) Appl. No.: 12/493,276

(22) Filed: Jun. 29, 2009

(51) Int. Cl. B01D 39/16; D04H 13/00

(52) U.S. Cl. 210/490; 428/411.1; 428/523

(57) ABSTRACT

The present invention provides a multilayer web having at least a first layer and a second layer. The second layer attached to the first layer and the second layer comprising fibers produced from polymeric composition comprising a blend of a thermoplastic polymeric component and a functionalized polymeric component. The functionalized polymeric component is at least 26% by weight of the polymeric components of the second layer. The multilayer web is particularly suited for filtration media.

### FIELD OF THE INVENTION

The present invention generally relates to a laminated web which is useable as filtration media, in particular an air filtration media.

### BACKGROUND OF THE INVENTION

Laminated filtration media is generally known in the art as is evidenced by, for example, U.S. Pat. No. 5,721,180 to Pike et al. In one aspect of this patent, a filter media prepared from a spunbond nonwoven web and a meltblown nonwoven web is described. Such filter media fabricated from meltblown fiber webs tend to provide high filtration efficiency because of the fine fiber size and the conformability of meltblown fibers that causes the fibers to come together as a dense, fine-pored web. The resulting interfiber pore structures are highly suitable for mechanically trapping or screening fine particles.

Filtration media desirably exhibit the highest filtration efficiency at the lowest possible pressure drop. However, adding additional layers to a filter media generally increases the pressure drop. In this regard, the filtration efficiencies of many filters can be improved, without a corresponding increase in pressure drop, by electrostatically charging the materials in order to impart a charge to the filter media. The use of electrets for filtration applications has been known for some time. The advantage of materials of this type is that the charge on the fibers considerably augments the filtration efficiency without making any contribution to the airflow resistance. Air filtration efficiency varies with the electrostatic charge; however, it is not a direct measure of the quantity or magnitude of charge in the media. Examples of filtration media that are electrets are also described in U.S. Pat. No. 5,721,180 to Pike et al.

One method of forming an electret material for use in forming a filtration media is described in U.S. Pat. No. 6,759,346 to Myers. As described, a telomer is added to another polymeric component used to prepare fibers in the filtration media. A telomer is a polymer having one or more functional groups located at the chain ends of the polymer. The telomer can be a homopolymer, copolymer, terpolymer, or other composition. However, with copolymers or other polymers with a plurality of repeat units, the terminal or end functional groups of the telomers do not have the same chemical functionality as the repeat units. Generally, the amount of the telomer amounts less than 25% by weight based on the polymeric components in the composition used to make fibers of a nonwoven web. Typically, the amount of the telomer is between 0.5% to 20% based on the weight of the entire polymeric composition.

There is a need in the art for a filter material that can be used to construct, for example, porous media that is resistant to delamination during handling and converting, while providing a high filtration efficiency at a low pressure drop. A need also exists for such a material which is abrasion resistant that can be also be used to construct a filter media without the necessity of multiple structural support layers or unnecessary pressure drop across the media to prevent abrading of one or more of the layers during filter manufacturing.

### SUMMARY OF THE INVENTION

Generally stated, the present invention provides a multilayer structure having a first layer and a second layer where the second layer is attached to the first layer. This second layer is made of fibers produced from polymeric composition containing a blend of a thermoplastic polymeric component and a functionalized polymeric component. The functionalized polymeric component has at least one functional end group and the functionalized polymeric component comprises at least 26% by weight of the polymeric components in the polymeric composition. It has been discovered that having at least 26% by weight of the polymeric components of the second layer being the functionalized polymer, the first and second layers will resist delamination during handling and the second layer will be abrasion resistant.

The present invention also provides a laminated filtration media having a first layer and a second layer where the second layer is attached to the first layer. This second layer is made of fibers produced from polymeric composition containing a blend of a thermoplastic polymeric component and a functionalized polymeric component. The functionalized polymeric component has at least one functional end group and the functionalized polymeric component comprises at least 26% by weight of the polymeric components in the polymeric composition. It has been discovered that having at least 26% by weight of the second layer of the laminate filtration media being the functionalized polymer, the first and second layers will remain laminated during filter formation.

In one embodiment of the present invention, the functional end group of the functionalized polymeric component may be an aldehyde, an acid halide, an acid anhydride, a carboxylic acid, an amine, an amine salt, an amide, a sulfonic acid amides, a sulfonic acid or a salt thereof, a thiol, an epoxide, an alcohol, an acyl halide, or any derivative thereof.

Generally the functionalized polymeric component is between about 30% to about 90% by weight of the polymeric components in the second layer. More particularly, the functionalized polymeric component is about 35% to about 80% by weight of the polymeric components in the polymeric composition.

In one embodiment of the present invention, the first layer of the multilayer structure or filtration media may be a nonwoven web, a woven web, a fibrillated film, a foam, a porous film or laminates thereof. On particular first layer usable in the present invention includes a spunbond nonwoven web.

In a further embodiment, the second layer of the multilayer structure or filtration media is a meltblown nonwoven web.

By providing the laminated filtration media of the present invention, it has been surprisingly discovered that the laminate of the present invention has improved filtration properties as compared to filter media having a smaller percentage of the functionalize polymeric component in a similar second layer.

### BRIEF DESCRIPTION OF THE DRAWINGS

FIG. 1 shows a schematic diagram of a process line for electret treating a laminate of the present invention.

### DEFINITIONS

It should be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As used herein, the term “nonwoven web” means a web having a structure of individual fibers or threads which are interlaid, but not in an identifiable manner as in a knitted web. Nonwoven webs have been formed from many processes, such as, for example, meltblowing processes, spunbonding processes, air-laying processes, coforming processes and bonded carded web processes. The basis weight of nonwoven webs is usually expressed in ounces of material per square yard (osy) or grams per square meter (gsm) and the fiber diameters are usually expressed in microns, or in the case of staple fibers, denier. It is noted that to convert from osy to gsm, multiply osy by 33.91.

As used herein, the terms “filter media” or “filtration media” are used interchangeable herein and are intended to mean a material which is used in fluid filtration to remove particles from the fluid. The fluid which is filtered with the filter media includes gas phase fluids, liquid phase fluids and fluids having both gas and liquid phases.

As used herein the term “spunbond fibers” refers to small diameter fibers of molecularly oriented polymeric material. Spunbond fibers may be formed by extruding molten thermoplastic material as fibers from a plurality of fine, usually circular capillaries of a spinneret with the diameter of the extruded fibers then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having an average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al., each is hereby incorporated by reference in its entirety.

Meltblown nonwoven webs are prepared from meltblown fibers. As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers are microfibers which may be continuous or discontinuous, are generally smaller than 10 microns in average diameter (using a sample size of at least 10), and are generally tacky when deposited onto a collecting surface.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “multicomponent fibers” refers to fibers or filaments which have been formed from at least two polymers extruded from separate extruders but spun together to form one fiber. Multicomponent fibers are also sometimes referred to as “conjugate” or “bicomponent” fibers or filaments. The term “bicomponent” means that there are two polymeric components making up the fibers. The polymers are usually different from each other, although conjugate fibers may be prepared from the same polymer, if the polymer in each component is different from one another in some physical property, such as, for example, melting point, glass transition temperature or the softening point. In all cases, the polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al.; the entire content of each is incorporated herein by reference. For two component fibers or filaments, the polymers may be present in ratios of 75/25, 50/50, 25/75 or any other desired ratios.

As used herein, the term “multiconstituent fibers” refers to fibers which have been formed from at least two polymers extruded from the same extruder as a blend or mixture. Multiconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Fibers of this general type are discussed in, for example, U.S. Pat. Nos. 5,108,827 and 5,294,482 to Gessner.

As used herein, “telechelic” polymer or “telomer” comprise polymers having one or more functional groups located at the chain ends of the polymer. The telomer can be a homopolymer, copolymer, terpolymer, or other composition. However, with copolymers or other polymers with a plurality of repeat units, the terminal or end functional groups of the telomers do not have the same chemical functionality as the repeat units. Telomers can have either one or a plurality of functional end groups and the average number of functional end groups for a given telomer will vary with the method of formation, degree of chain branching, and other factors known to those skilled in the art.

### DETAILED DESCRIPTION OF THE INVENTION

Generally speaking, the present invention is directed to a multilayer structure or web. The multilayer structure or web has a first layer and a second layer. The terms “first” and “second” as used herein are meant only to distinguish the layers or components and are not intended to specify any order in which the materials are joined to one another, or order of blending of the component, or any order in which the structure or web is intended to be used. With respect to the structure or web of the present invention, the first and second layer of the structure or web are joined to one another such that the second layer is attached to the first layer. With respect to the polymeric composition of the fibers of the second layer, the first and second thermoplastic component are blended or mixed with one another.

The multilayer structure of the present invention may be used in many different applications, including filtration, wipes, adsorbents, face mask, ground covers, apparel, including safety apparel, absorbent articles such as diapers, feminine care pads and the like, and as well as other similar applications that laminate structures have been utilized. The multilayer structure or web of the present invention is particular useful as filtration media.

Generally speaking, the first layer constitutes a support layer for the second layer. The first layer of the multilayer structure or web may be prepared from any suitable material which have been used in other filtration materials, wipes or other similar structures, including, for example, a nonwoven web, a woven web, a fibrillated film, a foam, a porous film or laminates thereof. Materials suitable for preparing the first layer include synthetic materials, natural materials or a combination thereof. One particularly useable first layer from the standpoint of cost and ease of manufacture is a nonwoven web. Suitable nonwoven webs include, for example, a spunbond nonwoven web, a bonded carded nonwoven web, an airlaid nonwoven web, a coform nonwoven web or a meltblown nonwoven web. Of these nonwoven webs, one particularly useful nonwoven web is a spunbond nonwoven web.

The nonwoven webs used may be prepared from a wide variety of materials including synthetic fibers, natural fibers and combinations thereof. The choice of fibers depends upon, for example, cost and desired properties for the nonwoven web. Synthetic fibers may be monocomponent, multicomponent (conjugate fibers) or mixtures thereof. The synthetic fibers may also be used in conjunction other fibers including natural fibers. Suitable natural fibers include, for example, cotton, linen, jute, hemp, wool, wood pulp and the like. In addition, regenerated cellulosic fibers such as viscose rayon or modified cellulosic fibers, such as cellulose acetate may also be used.

The monocomponent and multicomponent synthetic fibers suitable for use in the first layer can be produced from a wide variety of thermoplastic polymers to form the fibers. Suitable polymers for the first thermoplastic polymer include, but are not limited to, polyolefins (e.g., polypropylene and polyethylene), polycondensates (e.g., polyamides, polyesters, including polylactic acid, polycarbonates, and polyarylates), polyols, polydienes, polyurethanes, polyethers, polyacrylates, polyacetals, polyimides, cellulose esters, polystyrenes, fluoropolymers, polyhydroxy alkanates and polyphenylenesulfide and other known thermoplastic polymers. As is noted above, the “polymer” generally includes but is not limited to, homopolymers, copolymers, such as for example, block, graft, random and alternating copolymers, terpolymers, etc. and blends and modifications thereof. Generally, particular thermoplastic polymers useable are a non-polar polymers such as a polyolefin, such as, for example, polyethylene, polypropylene, poly(1-butene), poly(2-butene), poly(1-pentene), poly(2-pentene), poly(1-methyl-1-pentene), poly(3-methyl-1-pentane), and poly(4-methyl-1-pentane) and so forth. The first thermoplastic polymer may be a blend or mixture of two or more polymers. As an example, the first thermoplastic polymer may be a polymer blend of polyolefin polymers such as, for example, the polypropylene/polybutylene blends, such as those described in U.S. Pat. No. 5,165,979 to Watkins et al. and U.S. Pat. No. 5,204,174 to DaPonte et al., and polypropylene/poly-1-methyl pentene blends. The selection of the specific polymer or polymers will vary with respect to the chosen process for making the fibrous second layer of the laminate. As an example, the desired polymer rheology is different for those used for making films as opposed to fibers and further, with respect to fiber forming processes, the desired polymer composition and rheology differs for polymers used for making spunbond fibers and those for making meltblown fibers. The desired polymer composition and/or rheology for a particular manufacturing process are known to those skilled in the art.

Suitable polymers for forming multicomponent (conjugate) fibers generally include those polymers listed above. Generally, multicomponent fibers are made from two different components having differing melting points. One or more components have high melting points and one or more components have a lower melting point. Typically, there are two components present, one having a higher melting point and the other having a lower melting point. Particularly suitable polymers for the high melting point component include polypropylene, copolymers of polypropylene and polyethylene and blends thereof. Particularly suitable polymers for the lower melting point component include polyethylene, more particularly linear low density polyethylene, high density polyethylene and blends thereof. One particular suitable combination of component for multicomponent fibers is one component is polypropylene and the other component is polyethylene.

The actual selection of the first layer components or the type of first layer used as the support the second layer of the present invention is not critical to the present invention. However, when multilayer structure or web is used as a filtration media, the first layer should be selected such that the layer does not contribute too much pressure drop across the filter media without offering some degree of filtration efficiency. Alternatively, the first layer can offer very little filtration efficiency which providing a minimal pressure drop. Spunbond nonwoven webs are effective in supporting the second layer of the laminate of the present invention and have a relatively small pressure drop.

Particularly suited for the first layer is a lofty bicomponent spunbond having a basis weight between about 0.5 and 5.0 ounces per square yard (osy) (17 to 170 grams per square meter (gsm)). Lofty bicomponent spunbond has a relatively low density and a high degree of bulk. The density of the lofty bicomponent spunbond is generally between about 0.01 g/cm³ and 0.1 g/cm³

The second layer of the multilayer structure or web is a nonwoven web and may be a spunbond nonwoven web, a bonded carded nonwoven web, an airlaid nonwoven web, a coform nonwoven web or a meltblown nonwoven web. Of these nonwoven webs, one particularly useful nonwoven web is the meltblown nonwoven web. When used as a filtration media, the second layer is generally selected to provide filtration efficiency to the filtration media.

The second layer is a fibrous layer prepared from a polymeric composition containing a first thermoplastic polymeric component and a second thermoplastic polymer, wherein the second thermoplastic component has at least one functional end group. This polymeric composition of the fibers is generally a blend or mixture of the first thermoplastic polymer and the second thermoplastic polymer. Each of the first and second thermoplastic polymers may be a homopolymer, a copolymer or a composition of polymeric components.

Suitable polymers for the first thermoplastic polymer include, but are not limited to, polyolefins (e.g., polypropylene and polyethylene), polycondensates (e.g., polyamides, polyesters, including polylactic acid, polycarbonates, and polyarylates), polyols, polydienes, polyurethanes, polyethers, polyacrylates, polyacetals, polyimides, cellulose esters, polystyrenes, fluoropolymers, polyhydroxy alkanates and polyphenylenesulfide and other known thermoplastic polymers. As is noted above, the “polymer” generally includes but is not limited to, homopolymers, copolymers, such as for example, block, graft, random and alternating copolymers, terpolymers, etc. and blends and modifications thereof. Generally, particular thermoplastic polymers useable as the first thermoplastic polymeric component are a non-polar polymer such as a polyolefin, such as, for example, polyethylene, polypropylene, poly(1-butene), poly(2-butene), poly(1-pentene), poly(2-pentene), poly(1-methyl-1-pentene), poly(3-methyl-1-pentane), and poly(4-methyl-1-pentane) and so forth. The first thermoplastic polymer may be a blend or mixture of two or more polymers. As an example, the first thermoplastic polymer may be a polymer blend of polyolefin polymers such as, for example, the polypropylene/polybutylene blends, such as those described in U.S. Pat. No. 5,165,979 to Watkins et al. and U.S. Pat. No. 5,204,174 to DaPonte et al., and polypropylene/poly-1-methyl pentene blends. The selection of the specific polymer or polymers will vary with respect to the chosen process for making the fibrous second layer of the laminate. As an example, the desired polymer rheology is different for those used for making films as opposed to fibers and further, with respect to fiber forming processes, the desired polymer composition and rheology differs for polymers used for making spunbond fibers and those for making meltblown fibers. The desired polymer composition and/or rheology for a particular manufacturing process are known to those skilled in the art.

The second thermoplastic polymer component is polymer having one or more polar functional units or groups. One particular second thermoplastic polymer which may be used in forming the second layer is a telomer or telechelic polymer. The second thermoplastic polymeric component or telomer is present in an amount of from greater than 26% of the total weight of the polymeric components of the polymeric of the second layer. Generally, the second thermoplastic polymeric component will make up at least 30% of the polymeric components of the polymeric composition of the second layer. More particularly, the second thermoplastic polymeric component will make up at least 35% of the polymeric components of the polymeric composition of the second layer. The upper limit for the second polymeric component is generally limited to about 90% by weight of the polymeric components of the polymeric composition of the second layer. Typically, the second polymer will make-up no more than about 80% by weight of the polymeric components of the polymeric composition of the second layer. Generally, the second polymeric must be present in an amount sufficient to achieve attachment of the second layer to the first layer and an amount sufficient to impart resistance to delamination and abrasion resistance. Generally, having second polymer making up between about 30% and about 60% by weight of the polymeric components in the polymeric composition will result in a good balance of resistance to delamination, abrasion resistance and cost. If less than 26% by weight of the second polymeric component is used in the polymeric composition of second layer, the structure will tend to delaminate during handling and will not offer acceptable abrasions resistance. The second polymeric component is generally more expensive than the first polymeric component. In a further aspect of the invention, the functional end groups will generally comprises between about 0.005% and about 2.0% and more generally between 0.5% and 1.5% by weight of the second thermoplastic polymeric component. In addition, the second thermoplastic polymer component can comprise one or more distinct polymers.

Generally, a telomer has a chain or backbone which is substantially similar to that of the first thermoplastic polymer component and even more particularly identical to that of the first thermoplastic polymer components. The functional end groups are groups capable of hydrogen bonding or undergoing a reaction, such as a condensation reaction, to form a covalent bond. Generally, the polar functional groups are groups such as, for example, an aldehyde, acid halide, acid anhydrides, carboxylic acids, amines, amine salts, amides, sulfonic acid amides, sulfonic acid and salts thereof, thiols, epoxides, alcohols, acyl halides, and derivatives thereof. Particularly preferred telomers include, but are not limited to, acid anhydride, carboxylic acid, amides, amines, and derivatives thereof.

Telomers and telechelic polymers are known in the art and various telomers and methods of making the same are described in Encyclopedia of Polymer Science and Engineering, vol. 16, pg. 494-554 (1989); the particular method utilized in making the telomer is not believed critical to practicing the present invention. As an example, telomers can be made by reactive grafting. In this regard, the desired polymer chains can be broken by peroxide cracking in the presence of the selected functional end group monomer. Peroxide cracking generates a free radical chain end that reacts with the functional groups and which thereby becomes the terminal or end group of the polymer chain. As particular examples, polyolefin-anhydride telomers (a polyolefin polymer having one or more anhydride end groups) suitable for use with the present invention are commercially available from Chemtura Corp. of Middlebury, Conn. under the trade name POLYBOND, such as POLYBOND 3200.

The second thermoplastic polymer component can also comprise random or block copolymers of two or more ethylinically unsaturated monomers, wherein one or more of the monomers possesses a polar functional group. As a particular example, the polar thermoplastic polymer can comprise copolymers of an olefin and a polar repeat unit such as, for example, copolymers of ethylene/acrylic acid as described in U.S. Pat. No. 5,817,415 to Chou. In addition, it is believed the second thermoplastic polymer component can comprise a non-polar polymer modified to include a polar functional group such as, for example, a polyolefin polymer randomly grafted to include a polar functional group. As particular examples, the second polyolefin polymer can comprise a polypropylene polymer backbone randomly grafted with a carboxylic acid as described in U.S. Pat. No. 4,626,263 to Inoue et al. and U.S. Pat. No. 5,409,766 to Yuasa et al. Copolymers or backbone grafted polymers, such as those described immediately above, tend to be incompatible with the first thermoplastic polymer due to the size and chemical nature of the functional groups positioned along the polymer backbone. Thus, grafted polymers of this type can form discrete phases or regions and are likened to biconstituent polymers which do not have a single or substantially homogeneous phase and instead usually form fibrils or protofibrils which start and end at random.

The second thermoplastic polymer component is desirably blended with the first thermoplastic polymer component in a manner designed to achieve a mixture or blend. As one example, the polymers can be blended using a master batch or dry blend technique. In this regard, the respective polymers are initially blended to form a master batch, typically in the form of pellets, prills or powder, having a higher weight percent of the second thermoplastic polymer component than ultimately desired in the polymeric matrix. The master batch is then mixed with pellets comprising the first thermoplastic polymer component and processed through a single-screw or multi-screw extruder. The ratio of the master batch and first thermoplastic polymer component is selected, based upon the weight percent of second thermoplastic polymer in the master batch, to achieve the desired ratio of first and second polymers. Where the mixture will be manufactured into a nonwoven material, additional components may be added to the blend as processing aids. Examples of processing aids include, for example, peroxides which may be added to decrease the melt viscosity of the blend. One such peroxide is 1,3 bis(tert-butyl peroxy-isopropyl) benzene available from Polyvel Inc. of Hammonton, N.J. as CR10PX2.

Generally speaking, production of finer fibers such as meltblown fibers is facilitated by having the polymeric component or components, as extruded, having a higher rather than a lower melt flow. As mentioned, the extruded melt viscosity of these polymers may be reduced (i.e., their melt flow rates increased) using one or more peroxides. Further information regarding peroxide addition to polymer pellets may be found in U.S. Pat. No. 4,451,589 to Morman et al., and improved barrier microfiber nonwoven webs which incorporate peroxides in the polymer are disclosed in U.S. Pat. No. 5,213,881 to Timmons et al. The amount and type of peroxides, if used, will be dependent on factors such as the desired overall melt viscosity or melt flow rate of the polymeric components included in the polymeric matrix, the individual starting melt flow rates of the individual polymeric components making up the matrix, the relative amounts of the individual polymeric components, etc.

In one particular embodiment of the present invention, the second layer is a meltblown nonwoven web. The meltblown nonwoven web may have a basis weight of about 0.10 osy (3.9 gsm) to about 3.0 osy (102 gsm). Generally, the meltblown layer will have a basis weight between 0.25 osy (8.5 gsm) and 1.0 osy (33.9 gsm). The meltblown nonwoven web may be formed directly on the first layer or support layer. By forming the meltblown nonwoven web directly on the first layer, it is unnecessary to bond the two layers together using heat, pressure or any other known bonding means. The meltblown layer of the laminate will adhere directly to the first layer. Therefore the resulting laminate will not be unnecessarily compressed to ensure that the laminate will not delaminate during converting into a filter media.

In addition, one or more of the layers of the multilayer structure or filtration media may contain a ferroelectric material. The term “ferroelectric material” is used herein to mean a crystalline material which possesses a spontaneous polarization which may be reoriented by the application of an external electric field. The term includes any phase or combination of phases exhibiting a spontaneous polarization, the magnitude and orientation of which can be altered as a function of temperature and externally applied electric fields. The term also is meant to include a single ferroelectric material and mixtures of two or more ferroelectric materials of the same class or of different classes. The term further includes a “doped” ferroelectric material, i.e., a ferroelectric material which contains minor amounts of elemental substituents, as well as solid solutions of such substituents in the host ferroelectric material. Ferroelectric materials exhibit a “Curie point” or “Curie temperature,” which refers to a critical temperature above which the spontaneous polarization vanishes. The Curie temperature often is indicated herein as “T_{c}”.

Examples of ferroelectric materials include, without limitation, perovskites, tungsten bronzes, bismuth oxide layered materials, pyrochlores, alums, Rochelle salts, dihydrogen phosphates, dihydrogen arsenates, guanidine aluminum sulfate hexahydrate, triglycine sulfate, colemanite, and thiourea. Thus, ferroelectric materials may be inorganic or organic in nature. Inorganic ferroelectric materials are desired because of their generally superior thermal stability. Examples of various exemplary ferroelectric materials are discussed below.

Perovskites are a particularly desirable ferroelectric material due to their ability to form a wide variety of solid solutions from simple binary and ternary solutions to very complex multicomponent solutions. Some examples include, but are not limited to, BaSrTiO₃, BaTiO₃, Pb(Co_{0.25}Mn_{0.25}W_{0.5})O₃, and numerous forms of barium titanate and lead titanate doped with niobium oxide, antimony oxide, and lanthanum oxide, to name a few by way of illustration only. The ability to form extensive solid solutions of perovskite-type compounds allows one skilled in the art to systematically alter the electrical properties of the material by formation of a solid solution or addition of a dopant phase. In addition, perovskite-related octahedral structures have a structure similar to that of perovskites, and are likewise exemplary ferroelectric materials, examples include, but are not limited to, lithium niobate (LiNbO₃) and lithium tantalate (LiTaO₃). These materials are intended to be included in the term “perovskites.” Additionally, a further example of ferroelectric materials include bismuth oxide layered materials which comprise complex layered structures of perovskite layers interleaved with bismuth oxide layers. An exemplary bismuth oxide layered compound is lead bismuth niobate (PbBiNb₂O₉). A more detailed description of suitable ferroelectric materials is provided in commonly assigned U.S. Pat. No. 5,800,866 to Myers et al., the entire contents of which are incorporated herein by reference.

Generally, the ferroelectric material will be added to the layers of the multilayer structure. Typically, the ferroelectric material will be added the polymeric composition used to prepare the second layer of the multilayer structure. The amount of ferroelectric material contained in the polymeric composition used to produce the second layer is generally within the range of from about 0.01 to about 50 percent by weight based on the weight of the polymeric composition of the second layer. Desirably, the amount of ferroelectric material within the polymeric composition is between about 0.05 to about 30 percent by weight and more desirably between about 0.1 to about 20 percent by weight of the polymeric components. In one particular embodiment, the ferroelectric material may be present in an amount between about 0.5 to about 5 percent by weight of the polymeric composition used to prepared the second layer of the. On a percent by volume basis, the amount of ferroelectric material present in the polymeric composition generally will be in a range of from about 0.001 to about 13 percent by volume and desirably from about 0.01 to about 8 percent by volume and more desirably from about 0.1 to about 5 percent by volume and still more desirably from about 0.1 to about 2 percent by volume of the polymeric composition. Desirably the ferroelectric material is dispersed within the polymeric composition or matrix as described herein below.

The ferroelectric material can be located randomly throughout the polymeric matrix of the polymer composition and, generally, is substantially uniformly distributed throughout the polymeric matrix. In this regard, the polymer composition is a zero/three composite. As used herein a “zero/three” composite refers to the dimensional connectivity of the ferroelectric material and the polymeric components of the polymeric composition. Connectivity is a macroscopic measure of the composite structure which considers the individual structures (i.e. the ferroelectric material and the polymer) continuity in the x, y, and z dimensions. The first number refers to continuity of the ferroelectric material within the composite and a zero rating indicates that the ferroelectric particles form discrete phases which are discontinuous in the x, y and z dimensions. The second number refers to the continuity of the polymeric portion of the composite and a three rating indicates that the polymeric portion of the composite is continuous in each of the x, y and z dimensions.

In addition, the desired particle size of the ferroelectric material will vary with respect to the particular manufacturing process (e.g. meltblown, spunbond, film and so forth) as well as the desired physical attributes of the article made therefrom. For example, with respect to melt extruded fibers or filaments, the longest dimension of the particles typically should be no greater than about 50 percent of the diameter of the orifice through which the composite is extruded. Desirably, the ferroelectric material has a longest dimension in a range of from about 10 nanometers to about 10 micrometers. It has been found that many nonwoven fiber forming processes inherently orient the ferroelectric particle such that the longest dimension of the particle is oriented substantially parallel with the machine direction of the fabric (i.e. the direction in which the fabric is produced) and thus a wide range of particle sizes are suitable for use in such materials. The longest dimension of the average ferroelectric particle is desirably less than about 2 micrometers and/or desirably less than about 50% of the fiber thickness. In addition, the ferroelectric material can comprise nano-size particles. Suitable ferroelectric materials can be synthesized to form particles of the desired size and/or can be destructured to form particles of the desired size. The term “destructured” and variations thereof means a reduction in size of the ferroelectric particles.

The polymeric material can be formed and processed by one of various methods. As an example, the composite polymeric material may be formed by the following process: (i) destructuring the ferroelectric material in the presence of a liquid and a surfactant to give destructured particles, wherein the liquid is a solvent for the surfactant and the surfactant is chosen to stabilize the destructured particles against agglomeration; (ii) forming a composite of the stabilized, destructured ferroelectric material particles and polymeric components; and (iii) extruding the composite material to form fibers, film or other materials as desired. A mixture of the stabilized, destructured ferroelectric material particles and a thermoplastic polymer may be prepared by a variety of methods. As specific examples, methods of making such materials are described in U.S. Pat. No. 5,800,866 to Myers et al. and European Patent Application Publication No. 0902851-A1, each of which is incorporated here by reference.

The polymeric composition of the second layer can be processed by one of various means to form the desired structure including, but not limited to, melt extrusion, solution spinning, gel spinning, extrusion cast films, blown films, and so forth. Desirably, the polymeric composition is made into a porous substrate or sheet. Examples of suitable media into which the polymeric composition may be processed, include, but are not limited to, striated or fibrillated films, woven fabrics, reticulated foams, nonwoven webs, sintered porous materials and the like. Various nonwoven webs and laminates thereof, such as those described below, are particularly well suited for use as filtration media and wipes.

The polymeric composition may also be processed into a staple fiber webs, such as air-laid or bonded/carded webs. An exemplary staple fiber web is described in U.S. Pat. No. 4,315,881 to Nakajima et al.; the entire content of which is incorporated herein by reference. Staple fibers comprising the polymeric composition material can comprise a portion of or all of the staple fibers within the staple fiber web. As still further examples, additional media into which the polymeric composition may be processed or used with include multilayer laminates.

The polymeric material or the media into which it is processed may be electret treated so as to exhibit an electrostatic charge or field. As previously discussed, electrostatically charging the material can improve the filtration efficiency of the material. Various electret treatment techniques are known in the art and it is not believed that the method of electret treatment of the media is critical to the present invention and that numerous methods of electret treatment are suitable for use with the present invention. Suitable electret treating processes include, but are not limited to, plasma-contact, electron beam, corona discharge and so forth. Electrical or corona poled treatments can be applied either during and/or after the film formation or fiber spinning process. As examples thereof, methods for treating materials to form electrets are disclosed in U.S. Pat. No. 4,215,682 to Kubic et al., U.S. Pat. No. 4,375,718 to Wadsworth et al., U.S. Pat. No. 4,588,537 to Klaase et al., U.S. Pat. No. 4,592,815 to Makao, and U.S. Pat. No. 5,401,446 to Tsai et al.; the entire contents of the aforesaid patents are incorporated herein by reference.

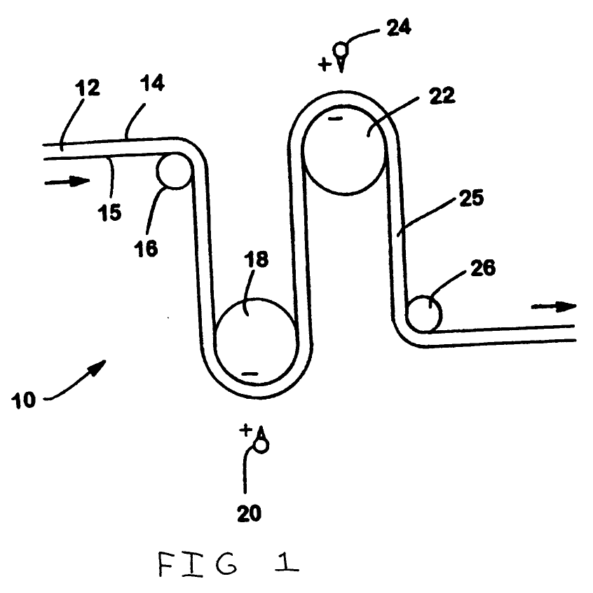

As one example, a filter or air-masking media can be charged or electretized by sequentially subjecting the material, such as a nonwoven web constructed from the polymeric composition, to a series of electric fields such that adjacent electret fields have opposite polarities with respect to one another. For example, a first side of the web is initially subjected to a positive charge while the second or opposed side is subjected to a negative charge, and then the first side is subjected to a negative charge and the second side to a positive charge thereby imparting permanent electrostatic charges in the material. A suitable method of electrostatically polarizing a polymeric material such as a nonwoven web is illustrated in FIG. 1. Polymeric sheet 12, having first side 14 and second side 16, is received by electret treatment apparatus 20. Polymeric sheet 12 is directed into apparatus 20 with second side 16 in contact with guiding roller 22. First side 14 of sheet 12 comes in contact with first charging drum 24, having a negative electrical potential, while second side 16 of sheet 12 is adjacent first charging electrode 26, having a positive electrical potential. As sheet 12 passes between first charging drum 24 and first charging electrode 26, electrostatic charges develop therein. The polymeric sheet 12 is then passed between second charging drum 28 and second charging electrode 30. Second side 16 of sheet 12 comes in contact with second charging drum 28, having a negative electrical potential, while first side 14 of sheet 12 is adjacent second charging electrode 30, having a positive electrical potential. The second treatment reverses the polarity of the electrostatic charges previously imparted within the web and creates a permanent electrostatic charge therein. The polarities of the charging drums and electrodes could be reversed. The electretized sheet 18 can then be passed to second guiding roller 32 and removed from electret treatment apparatus 20. Additionally, other devices or apparatus could be utilized in lieu of those discussed in reference to FIG. 1.

The multilayer structure or the filtration media into which they have been processed can be used to make a variety of products and/or articles when further processed into an electret material as described above. As previously mentioned, filtration or filter media serve as examples. As used herein the term “filtration” or “filter” media can refer to fabrics which provide a desired level of barrier properties and is not limited to the strict or narrow definition of a filter which requires entrapment of particles. Thus, filter media of the present invention can be used in air and gas filtration media such as, for example, those used in HVAC filters, vacuum cleaner bags, respirators, air filters for engines, air filters for cabin air filtration, heating and/or air conditioner filters, and so forth. Additionally, the filter media of the present invention can also be utilized in infection control products such as, for example, medically oriented items such as face masks, wound dressings, sterilization wraps and the like. As a particular example, exemplary sterilization wraps and face masks are described in U.S. Pat. No. 4,969,457 to Hubbard et al., U.S. Pat. No. 5,649,925 to Reese et al., and U.S. Pat. No. 5,635,134 to Bourne et al., the entire contents of the aforesaid references are incorporated herein by reference. Further, electret filter media can be utilized in hand wipes and other similar applications. In this regard, the electret media can be particularly adept at picking up lint, dust and other fine particulate matter. Polymeric electret materials can comprise or be incorporated as a component within in a wide variety of articles. Furthermore, the polymeric composition or the media into which they have been processed can be used to make a variety of products without being processed into an electret material as well. By way of example, the polymeric composition could be used to create various liquid filter media including media for water filtration.

Test Procedures

Air Filtration Efficiency Measurements: The air filtration efficiencies of the substrates discussed below were evaluated using a TSI, Inc. (St. Paul, Minn.) Model 8130 Automated Filter Tester (AFT). The Model 8130 AFT measures particle filtration characteristics for air filtration media. The AFT utilizes a compressed air nebulizer to generate a submicron aerosol of sodium chloride particles which serves as the challenge aerosol for measuring filter performance. The characteristic size of the particles used in these measurements was 0.1 micrometer count mean diameter. Typical air flow rates were between 80 liters per minute and 85 liters per minute. The AFT test was performed on a sample area of about 100 cm². The performance or efficiency of a filter medium is expressed as the percentage of sodium chloride particles which penetrate the filter. Penetration is defined as transmission of a particle through the filter medium. The transmitted particles were detected downstream from the filter. Light scattering was used for the detection and counting of the sodium chloride particles both upstream of the filter and downstream of the filter. The Model 8130 Automated Filter Tester (AFT) displays the downstream particle percentage. The percent efficiency (ε) may be calculated from the percent penetration according to the formula:

ε=100%−the downstream particle percentage

Further information regarding the TSI Model 8130 AFT or the test procedures used to perform the efficiency test using the TSI Model 8130 may be obtained from TSI and at www.tsi.com.

Air Permeability: The Air Permeability of the nonwoven fabric of the present invention is determined by a test that measures the air permeability of fabrics in terms of cubic feet of air per square foot of sheet using a Textest FX3200 air permeability tester manufactured by Textest Ltd., Zurich, Switzerland. All tests are conducted in a laboratory with a temperature of 23+/−2° C. and 50+/−5% RH. Specifically, a piece of the nonwoven web to be tested is clamped over the 2.75-inch diameter fabric test opening. Placing folds or crimps above the fabric test opening is to be avoided if at all possible. The unit is turned on and the air flow through the sample is increased until the differential pressure of about 0.5 inches of water gauge. The output reading is the air flow rate in units of cubic feet of air per minute per square foot of sample at 0.5 inches of water gauge differential pressure.

ASHRAE 52.2-1999: Method of Testing General Ventilation Air Cleaning Devices for Removal Efficiency by Particle Size

This test, which is a filter industry standard test, has a standard procedure which is incorporated by reference. In summary, the test measures the efficiency of a filter medium in removing particles of specific diameter as the filter becomes loaded with standardized loading dust. The loading dust is fed at interval stages to simulate accumulation of particles during service life. The challenge aerosol for filtration efficiency testing is solid-phase potassium chloride (KCl) generated from an aqueous solution. An aerosol generator products KCl particles in twelve size ranges for filtration efficiency determination. The minimum efficiency observed over the loading sequence for each particle size range is used to calculate composite average efficiency values for three particle size ranges: 0.3 to 1.0 micron (E1), 1.0 to 3.0 microns (E2), and 3.0 to 10 microns (E3). Sample of the filter material were pleated into a configuration which is 24 inches×24 inches×2 inches.

The loading dust used to simulate particle accumulation in service is composed, by weight, of 72% SAE Standard J726 test dust (fine), 23% powdered carbon, and 5% milled cotton linters. The efficiency of clean filler medium is measured at one of the flow rates specified in the standard. A feeding apparatus then sends a flow of dust particles to load the filter medium to various pressure rise intervals until the specified final resistance is achieved. The efficiency of the filter to capture KCl particles is determined after each loading step. The efficiency of the filter medium is determined by measuring the particle size distribution and number of particles in the air stream, at positions upstream and downstream of the filter medium. The particle size removal efficiency (“PSE”) is defined as:

PSE=100×(1−(downstream particle count/upstream particle count)

The particle counts and size can be measured using a HIAC/ROYCO Model 8000 automatic particle counter and a HIAC/ROYCO Model 1230 sensor.

The results of this test procedure are reported in MERV (minimum efficiency rating). The higher the MERV value, the more efficient the filter is in filtering the gases.

### EXAMPLES

### Example 1

### Comparative

A filter media was constructed from a previously produced meltblown layer that was unwound between two layers of low loft bicomponent spunbond. The resulting three layer “stack” of materials was through-air bonded, thereby forming a three layer filter media. The media was then electret treated and wound into roll form. The meltblown weighed 0.53 osy and was produced from polypropylene polymer (Basell PF-015 available from Basell North America, Inc. of Elkton, Md.) containing 5% maleic anhydride telomer (Polybond 3200 available from Chemtura Corp. of Middlebury, Conn.), 0.5% BaTiO₃ (added as 5 weight % of SCC-24804 available as a concentrate pellet containing 10% BaTiO₃ in isotactic polypropylene from Standridge Color Corp. of Social Circle, Ga.), and approximately 1% TiO₂ concentrate (SCC-4837 available from Standridge Color Corp.). The outer spunbond layers were produced from polypropylene (3155 available from ExxonMobil Chemical Company of Houston, Tex.) and polyethylene (XUS61800.41 available from Dow Chemical Corp. of Midland, Mich.) in a side-by-side fiber configuration. Each spunbond layer weighed approximately 1.44 osy.

### Example 2

### Comparative

A filter media was constructed from a laminate structure. A 3 osy low loft bicomponent spunbond which was previously produced was unwound beneath a meltblown die which was forming meltblown fibers. The meltblown fibers were produced from a blend containing 55% (w/w) syndiotactic polypropylene (Finaplas 1751 available from Atofina Petrochemicals USA of LaPorte, Tex.), 35% (w/w) isotactic polypropylene (3155 available from the ExxonMobil Chemical Company of Houston, Tex.), 5% (w/w) maleic anhydride telomer (Polybond 3200 available from Chemtura Corp. of Middlebury, Conn.), 0.5% BaTiO₃ (added as 5 weight % of SCC-24804 available as a concentrate pellet containing 20% BaTiO₃ in isotactic polypropylene from Standridge Color Corp. of Social Circle, Ga.). To the polymeric composition is added 2% (w/w) peroxide concentrate (CR10PX2 available from Polyvel, Inc. of Polyvel Inc. of Hammonton, N.J.) as a processing aid. The weight of the meltblown that was added to the spunbond layer was 0.53 osy. Following the addition of the meltblown to the bicomponent spunbond, the resultant 2-layer composite media was electret treated and wound into roll form.

### Example 3

### Comparative

A filter media was constructed from a laminate structure. A 3 osy low loft bicomponent spunbond which was previously produced was unwound beneath a meltblown die which was forming meltblown fibers. The meltblown fibers were produced from a blend containing from a blend of polymers comprising 55% (w/w) syndiotactic polypropylene (Finaplas 1751 available from Atofina Petrochemicals USA of LaPorte, Tex.), 35% (w/w) isotactic polypropylene (3155 available from the ExxonMobil Chemical Company of Houston, Tex.), 5% (w/w) maleic anhydride telomer (Polybond 3200 available from Chemtura Corp. of Middlebury, Conn.), 0.5% BaTiO₃ (added as 5 weight % of SCC-24804 available as a concentrate pellet containing 20% BaTiO₃ in isotactic polypropylene from Standridge Color Corp. of Social Circle, Ga.). To the polymeric composition is added 1.25% by weight of Vulcup peroxide as a processing aid. The weight of the meltblown that was added to the spunbond layer was 0.53 osy. Following the addition of the meltblown to the bicomponent spunbond, the resultant 2 layer-media was electret treated and wound into roll form.

### Example 4

A filter media was constructed from a laminate structure. A 3 osy low loft bicomponent spunbond which was previously produced was unwound beneath a meltblown die which was forming meltblown fibers. The meltblown fibers were produced from a blend containing from a blend of polymers comprising 60% (w/w) of polypropylene (ExxonMobil 3546), and 40% (w/w) maleic anhydride telomer (Polybond 3200 available from Chemtura Corp. of Middlebury, Conn.), The weight of the meltblown that was added to the spunbond layer was 0.53 osy. Following the addition of the meltblown to the bicomponent spunbond, the resultant 2-layer composite media was electret treated and wound into roll form.

Each of the filter media described above was tested for Percent Penetration (Pen %), and Air Permeability (AP). The media was formed into finished filters and then tested for Differential Pressure (DP), Minimum Efficiency Reporting Value (MERV), efficiency values for three particle size ranges: 0.3 to 1.0 micron (E1), 1.0 to 3.0 microns (E2), and 3.0 to 10 microns (E3), and Dust holding capacity in accordance with the ASHRAE 52.2 and 52.1 test procedures described above. Three samples of each filter media was tested and the test results are presented in TABLE 1.

TABLE 1

| | | AP | | | | | | |
|---|---|---|---|---|---|---|---|---|
| | | ft³min/ | | | | | | |
| | | ft² | | | | | | |
| | | @0.5″ | DP | | | | | |
| Exam- | Pen | Water | In | | | | | DHC |
| ple | % | gage | H₂O | MERV | E1 | E2 | E3 | Grams |
| 1 | 20 | 73 | 0.34 | 14 | 81.4 | 96.5 | 99.4 | 83 |
| | | | 0.308 | 14 | 81.1 | 95.8 | 99.7 | |
| | | | 0.305 | 14 | 80.8 | 95.6 | 99.6 | |
| 2 | 26 | 67 | 0.394 | 13 | 69.3 | 93.1 | 99 | 21 |
| | | | 0.418 | 13 | 71.7 | 92.7 | 98.7 | |
| | | | 0.436 | 13 | 70.9 | 93.2 | 98.8 | |
| 3 | 29 | 96 | 0.331 | 13 | 67.5 | 90.3 | 98.8 | 77 |
| | | | 0.312 | 13 | 68.2 | 90.3 | 98.3 | |
| | | | 0.305 | 13 | 69.3 | 92.3 | 99 | |
| 4 | 21.2 | 69.5 | 0.316 | 14 | 76.8 | 93.1 | 98 | 89 |
| | | | 0.314 | 14 | 77.5 | 94 | 99.2 | |
| | | | 0.321 | 14 | 76.2 | 94.2 | 99.1 | |

Other attempts were made to make finished filters containing less than 5% of the telomer. However, these filters tend to delaminate during preparation of the final filter.

Although the present invention has been described with reference to various embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

1. A multilayer web comprising
a first layer; and
a second layer attached to the first layer, the second layer comprising fibers produced from polymeric composition comprising a blend of a thermoplastic polymeric component and a functionalized polymeric component, said functionalized polymeric component comprises at least one functional end group and said functionalized polymeric component comprises at least 26% by weight of the polymeric components in the polymeric composition.

2. The multilayer web according to claim 1, wherein said at least one functional end group is selected from the group consisting of aldehyde, acid halide, acid anhydrides, carboxylic acids, amines, amine salts, amides, sulfonic acid amides, sulfonic acid and salts thereof, thiols, epoxides, alcohols, acyl halides, and derivatives thereof.

3. The multilayer web according to claim 1, wherein the functionalized polymeric component comprises about 30% to about 90% by weight of the polymeric components in the polymeric composition.

4. The multilayer web according to claim 1, wherein the first layer comprises a nonwoven web, a woven web, a fibrillated film, a foam, a porous film or laminates thereof.

5. The multilayer web according to claim 1, wherein the thermoplastic polymeric component comprises polypropylene.

6. The multilayer web according to claim 1, wherein the second layer is a meltblown nonwoven web.

7. A filtration media comprising
a first layer; and
a second layer attached to the first layer, the second layer comprising fibers produced from polymeric composition comprising a blend of a thermoplastic polymeric component and a functionalized polymeric component, said functionalized polymeric component comprises at least one functional end group and said functionalized polymeric component comprises at least 26% by weight of the polymeric components in the polymeric composition.

8. The filtration media according to claim 7, wherein said at least one functional end group is selected from the group consisting of aldehyde, acid halide, acid anhydrides, carboxylic acids, amines, amine salts, amides, sulfonic acid amides, sulfonic acid and salts thereof, thiols, epoxides, alcohols, acyl halides, and derivatives thereof.

9. The filtration media according to claim 7, wherein the functionalized polymeric component comprises about 30% to about 90% by weight of the polymeric components in the polymeric composition.

10. The filtration media according to claim 9, wherein the functionalized polymeric component comprises about 35% to about 80% by weight of the polymeric components in the polymeric composition.

11. The filtration media according to claim 7, wherein the first layer comprises a nonwoven web, a woven web, a fibrillated film, a foam, a porous film or laminates thereof.

12. The filtration media according to claim 7, wherein the thermoplastic polymeric component comprises a polyolefin.

13. The filtration media according to claim 12, wherein the thermoplastic polymeric component comprises polypropylene.

14. The filtration media according to claim 7, wherein the second layer is a meltblown nonwoven web.

15. The filtration media according to claim 7, wherein
the first layer comprises a spunbond nonwoven web; and
the second layer comprises fibers produced from polymeric composition comprising a blend of a thermoplastic polyolefin and a functionalized polymeric component, said functionalized polymeric component comprises at least one functional end group and said functionalized polymeric component comprises about 30% to about 90% by weight of the polymeric components in the second layer.

16. The filtration media according to claim 15, wherein the functional end group comprises an acid anhydride.

17. The filtration media according to claim 15, wherein the functionalized polymeric component comprises about 30% to about 60% by weight of the polymeric components in the polymeric composition.

18. The filtration media according to claim 7, wherein
the first layer comprises a spunbond nonwoven web comprising bicomponent filaments, wherein one of the components of the bicomponent filaments is polypropylene and the other component is polyethylene; and
the second layer comprises meltblown fibers produced from polymeric composition comprising a blend of a thermoplastic polyolefin and a functionalized polymeric component, said functionalized polymeric component comprises at least one functional end group and said functionalized polymeric component comprises about 30% to about 60% by weight of the polymeric components in the second layer.

19. The filtration media according to claim 18, wherein the functional end group comprises an acid anhydride.

20. The filtration media according to claim 18, wherein the functionalized polymeric component comprises a polyolefin having at least one functional end group.
